(19) United States
(12) Patent Application Publication
(10) Pub. No.: US 2022/0080948 A1
(43) Pub. Date: Mar. 17, 2022

(54) CONTROL SYSTEM FOR HYBRID VEHICLE

(71) Applicant: TOYOTA JIDOSHA KABUSHIKI KAISHA, Aichi (JP)

(72) Inventors: Tatsuya IMAMURA, Okazaki-shi (JP); Shigeru OKUWAKI, Gotemba-shi (JP)

(21) Appl. No.: 17/469,884

(22) Filed: Sep. 9, 2021

(30) Foreign Application Priority Data
Sep. 17, 2020 (JP) 2020-156041

(51) Int. Cl. B60W 20/15; B60W 10/06; B60W 10/08; B60W 10/11; B60W 20/30; B60W 30/18

(52) U.S. Cl. CPC B60W 20/15; B60W 10/06; B60W 10/08; B60W 2520/10; B60W 20/30; B60W 30/18072; B60W 2540/10; B60W 10/11

(57) ABSTRACT

A control system for a hybrid vehicle configured to accelerate the coasting hybrid vehicle sharply in response to a depression of an accelerator pedal. A controller is configured to: shift an operating mode from low mode to high mode at a higher speed in a case that the hybrid vehicle coasts without depressing an accelerator pedal, compared to a case that the hybrid vehicle is propelled by depressing the accelerator pedal; and delay a timing to shift the operating mode from the low mode to the high mode for a predetermined period of time when accelerating the coasting hybrid vehicle by depressing the accelerator pedal.

### CROSS-REFERENCE TO RELATED APPLICATIONS

The present invention claims the benefit of Japanese Patent Application No. 2020-156041 filed on Sep. 17, 2020 with the Japanese Patent Office.

### BACKGROUND

### Field of the Invention

Embodiments of the present disclosure relate to the art of a control system for a hybrid vehicle in which a prime mover includes an engine and a motor, and in which an operating mode can be selected from a plurality of modes.

### Discussion of the Related Art

JP-B2-6451524 describes control systems for a hybrid vehicle in which a prime mover includes an engine and two motors. In the hybrid vehicle described in JP-B2-6451524, an output torque of the engine is distributed to a first motor and to an output member through a power split mechanism. The torque transmitted to the first motor is translated into electricity and supplied to a second motor to generate a torque, and the torque generated by the second motor is added to the torque of the engine delivered directly to drive wheels. An operating mode of the hybrid vehicle of this kind is selected from a hybrid-low mode and a hybrid-high mode, and a speed ratio between an engine speed and an output speed is changed by shifting the operating mode between the hybrid-low mode and the hybrid-high mode by manipulating a first clutch and a second clutch. Specifically, the speed ratio between the engine speed and the output speed in the hybrid-low mode is greater than that in the hybrid-high mode. That is, a drive torque generated in the hybrid-low mode is larger than that in the hybrid-high mode.

JP-A-2018-154327 also describes control systems for a hybrid vehicle in which a prime mover includes an engine and two motors. In the hybrid vehicle described in JP-A-2018-154327, a dual-motor mode to operate a first motor and a second motor as prime movers is established by halting rotation of a rotary member connected to the engine by a brake and manipulating a first clutch and a second clutch. The dual-motor mode includes an EV-low mode and an EV-high mode, and a speed ratio between a rotational speed of the first motor and an output speed is changed by shifting the operating mode between the EV-low mode and the EV-high mode by selectively engaging the first clutch and the second clutch. Specifically, the speed ratio between the rotational speed of the first motor and the output speed in the EV-low mode is greater than that in the EV-high mode. That is, a drive torque generated in the EV-low mode is larger than that in the EV-high mode.

As described in the foregoing prior art documents, the drive torque generated in the low mode is larger than the drive torque generated in the high mode in both of the hybrid mode and the EV mode. For example, when the hybrid vehicle coasting without depressing an accelerator pedal is accelerated by depressing the accelerator pedal, or when the hybrid vehicle is launched, the low mode will be established to generate a relatively large drive torque. Then, when the hybrid vehicle starts cruising at a predetermined speed while maintaining the accelerator pedal at a predetermined position, the operating mode of the hybrid vehicle will be shifted from the low mode to the high mode. Thereafter, when the accelerator pedal is further depressed to accelerate the hybrid vehicle significantly, the operating mode of the hybrid vehicle will be shifted to the low mode again to further increase the drive torque. If the above operations are executed in sequence, the first clutch and the second clutch are engaged and disengaged repeatedly to shift the operating mode repeatedly. As a result, it takes longer time to complete the operations of the clutches to shift the operating mode, and hence the shifting operation of the operating mode may not be completed promptly.

### SUMMARY

Aspects of embodiments of the present invention have been conceived noting the foregoing technical problems, and it is therefore an object of the present invention to provide a control system for a hybrid vehicle configured to accelerate a coasting hybrid vehicle sharply in response to a depression of an accelerator pedal.

The control system according to the exemplary embodiment of the present invention is applied to a hybrid vehicle comprising: a prime mover including an engine and a motor; a first differential mechanism that performs a differential action among a first rotary element that is connected to the engine, a second rotary element that is connected to the motor, and a third rotary element; a second differential mechanism that performs a differential action among a fourth rotary element that is connected to a pair of drive wheels, a fifth rotary element that is connected to the third rotary element, and a sixth rotary element; a first engagement device that selectively connects the first rotary element to the sixth rotary element; and a second engagement device that selectively connects any two of the fourth rotary element, the fifth rotary element, and the sixth rotary element. An operating mode of the hybrid vehicle is selected from a plurality of modes including: a low mode established by engaging the first engagement device; and a high mode established by engaging the second engagement device in which a torque delivered to the drive wheels is smaller compared to the low mode. In order to achieve the above-explained objective, according to the exemplary embodiment of the present disclosure, the control system comprises a controller that shifts the operating mode. Specifically, the controller is configured to: shift the operating mode from the low mode to the high mode at a higher speed of the hybrid vehicle in a case that the hybrid vehicle coasts without depressing an accelerator pedal, compared to a case that the hybrid vehicle is propelled by depressing the accelerator pedal; and delay a timing to shift the operating mode from the low mode to the high mode for a predetermined period of time when accelerating the coasting hybrid vehicle by depressing the accelerator pedal.

In a non-limiting embodiment, the controller may be further configured to: shift the operating mode between the low mode and the high mode with reference to a shifting map; determine whether an operating point in the shifting map is shifted from a low mode region where the low mode is selected to a high mode region where the high mode is selected, when the coasting hybrid vehicle is accelerated by depressing the accelerator pedal; and delay the timing to shift the operating mode from the low mode to the high mode for the predetermined period of time if the operating point in the shifting map is shifted from the low mode region to the high mode region by depressing the accelerator pedal to accelerate the coasting hybrid vehicle.

In a non-limiting embodiment, the operating point may be governed by a speed of the hybrid vehicle and a position of the accelerator pedal. In addition, the controller may be further configured to determine a satisfaction of a condition to shift the operating mode from the low mode to the high mode based on the position of the accelerator pedal.

In a non-limiting embodiment, the controller may be further configured to: determine whether the predetermined period of time has elapsed from a point at which the operating point in the map is shifted from the low mode region to the high mode region by depressing the accelerator pedal to accelerate the coasting hybrid vehicle; and maintain the operating mode to the low mode if the predetermined period of time has not yet elapsed from the point at which the operating point in the map is shifted from the low mode region to the high mode region.

In a non-limiting embodiment, the controller may be further configured to shift the operating mode from the low mode to the high mode if the predetermined period of time has elapsed from the point at which the operating point in the map is shifted from the low mode region to the high mode region.

In a non-limiting embodiment, the operating mode may further include a hybrid vehicle mode in which the hybrid vehicle is powered at least by the engine, and an electric vehicle mode in which the hybrid vehicle is powered by the motor. In addition, the controller may be further configured to delay the timing to shift the operating mode from the low mode to the high mode for the predetermined period of time if the operating point in the shifting map is shifted from the low mode region to the high mode region by depressing the accelerator pedal to accelerate the hybrid vehicle coasting in either the hybrid mode or the electric vehicle mode.

In a non-limiting embodiment, the controller may be further configured to shift the operating mode from the high mode to the low mode without delay when accelerating the coasting hybrid vehicle by depressing the accelerator pedal.

In a non-limiting embodiment, the controller may be further configured to shift the operating mode from the high mode to the low mode without delay if the operating point in the shifting map is shifted from the high mode region to the low mode region by depressing the accelerator pedal to accelerate the coasting hybrid vehicle.

In a non-limiting embodiment, the shifting map may include: a first shifting map in which the operating mode is shifted from the low mode to the high mode at the higher speed of the hybrid vehicle in a case that the hybrid vehicle coasts without depressing an accelerator pedal, compared to a case that the hybrid vehicle is propelled by depressing the accelerator pedal; and a second shifting map in which the operating mode is shifted from the low mode to the high mode at a lower speed compared to the first shifting map, in a case that the hybrid vehicle coasts without depressing an accelerator pedal. In addition, the controller may be further configured to: delay the timing to shift the operating mode from the low mode to the high mode for the predetermined period of time with reference to the first shifting map in a case that the accelerator pedal is depressed at a rate equal to or faster than a threshold speed, or that a sporty mode is selected to accelerate the hybrid vehicle sharply; and delay the timing to shift the operating mode from the low mode to the high mode for the predetermined period of time with reference to the second shifting map in a case that that the accelerator pedal is depressed at a rate slower than the threshold speed, or that an economy mode is selected to improve energy efficiency.

As described, an operating mode of the hybrid vehicle may be selected from a low mode that is established by engaging the first engagement device, and a high mode that is established by engaging the second engagement device. In order to achieve the above-explained advantages, according to the exemplary embodiment of the present disclosure, a speed of the hybrid vehicle to shift the operating mode from the low mode to the high mode during coasting is set to a higher level, compared to that of a case in which the hybrid vehicle is propelled by depressing the accelerator pedal. In addition, the control system according to the exemplary embodiment of the present disclosure delays a timing to shift the operating mode from the low mode to the high mode for a predetermined period of time when accelerating the coasting hybrid vehicle by depressing the accelerator pedal. Specifically, even if the operating point in the shifting map is shifted from the Low mode region to the High mode region by depressing the accelerator pedal to accelerate the coasting hybrid vehicle, the control system maintains the operating mode to the low mode for the predetermined period of time.

For example, if the driver depresses the accelerator pedal deeply to accelerate the coasting hybrid vehicle, the operating point in the shifting map may be shifted from the Low mode region to the Low mode region via the High mode region. In this situation, according to the exemplary embodiment of the present disclosure, the operating mode is maintained to the Low mode for the predetermined period of time. According to the exemplary embodiment of the present disclosure, therefore, the actual operating mode will not be shifted unnecessarily and repeatedly. In other words, engagement/disengagement operations of the engagement devices will not be executed unnecessarily and repeatedly. For these reasons, the drive force may be increased smoothly to accelerate the coasting hybrid vehicle sharply in the Low mode when the accelerator pedal is depressed deeply.

### BRIEF DESCRIPTION OF THE DRAWINGS

Features, aspects, and advantages of exemplary embodiments of the present invention will become better understood with reference to the following description and accompanying drawings, which should not limit the invention in any way.

FIG. 1 is a skeleton diagram showing a drive unit of a hybrid vehicle to which the control system according to the example of the present disclosure is applied;

FIG. 2 is a block diagram showing a structure of an electronic control unit;

FIG. 3 is a table showing engagement states of engagement devices and operating conditions of prime movers in each operating mode;

FIG. 4 is a nomographic diagram showing a situation in a HV-High mode;

FIG. 5 is a nomographic diagram showing a situation in a HV-Low mode;

FIG. 6 is a nomographic diagram showing a situation in a fixed mode;

FIG. 7 is a nomographic diagram showing a situation in an EV-Low mode;

FIG. 8 is a nomographic diagram showing a situation in an EV-High mode;

FIG. 9 is a nomographic diagram showing a situation in a single-motor mode;

FIG. 10 shows a map for determining an operating mode during propulsion in a CS mode;

FIG. 11 shows a map for determining an operating mode during propulsion in a CD mode;

FIG. 12 shows a map for shifting the operating mode between a Low mode and a High mode;

FIG. 13 is a flowchart showing one example of a routine executed by the control system according to the example of the present disclosure;

FIG. 14 is a time chart showing a temporal change in the situation of the hybrid vehicle during execution of the routine shown in FIG. 13; and

FIG. 15 is a map for shifting the operating mode between the Low mode and the High mode in an economy mode.

### DETAILED DESCRIPTION OF THE PREFERRED EMBODIMENT(S)

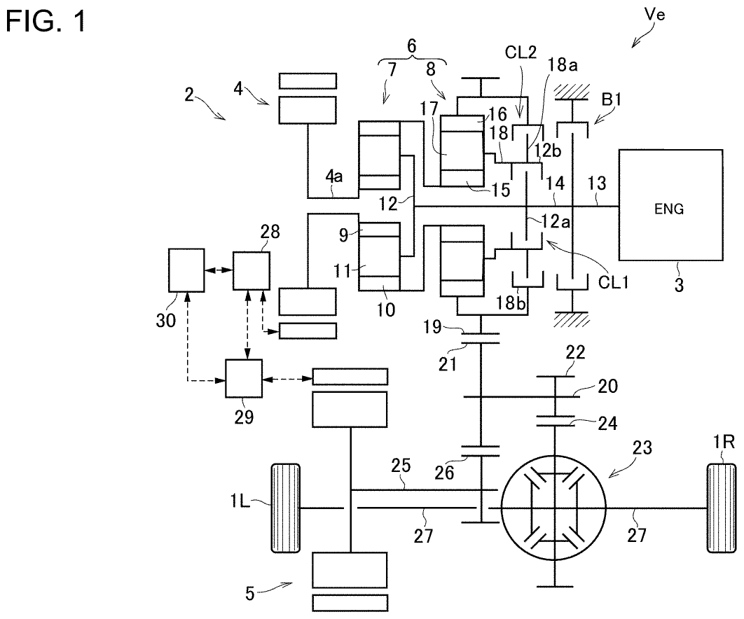

An exemplary embodiment of the present invention will now be explained with reference to the accompanying drawings. Referring now to FIG. 1, there is shown one example of a structure of a hybrid vehicle (as will be simply called the “vehicle” hereinafter) Ve to which the control system according to the exemplary embodiment of the present disclosure is applied. Specifically, FIG. 1 shows a drive unit 2 of the vehicle Ve that drives a pair of front wheels 1R and 1L, and the drive unit 2 comprises an engine (referred to as “ENG” in the drawings) 3, a first motor (referred to as “MG1” in the drawings) 4, and a second motor (referred to as “MG2” in the drawings) 5. According to the exemplary embodiment, a motor-generator having a generating function is adopted as the first motor 4. In the vehicle Ve, a speed of the engine 3 is controlled by the first motor 4, and the second motor 5 is driven by electric power generated by the first motor 4 to generate a drive force for propelling the vehicle Ve. Optionally, the motor-generator having a generating function may also be employed as the second motor 5.

A power split mechanism 6 as a differential mechanism is connected to the engine 3. The power split mechanism 6 includes a power split section 7 that distributes an output torque of the engine 3 to the first motor 4 side and to an output side, and a transmission section 8 that alters a torque split ratio.

In the vehicle Ve shown in FIG. 1, a single-pinion planetary gear unit adapted to perform differential action among three rotary elements is adopted as the power split section 7. Accordingly, the power split section 7 serves as a first differential mechanism of the embodiment. Specifically, the power split section 7 comprises: a sun gear 9; a ring gear 10 as an internal gear arranged concentrically around the sun gear 9; a plurality of pinion gears 11 interposed between the sun gear 9 and the ring gear 10 while being meshed with the both gears 9 and 10; and a carrier 12 supporting the pinion gears 11 in a rotatable manner. In the power split mechanism 6, accordingly, the carrier 12 serves as a first rotary element, the sun gear 9 serves as a second rotary element, and the ring gear 10 serves as a third rotary element.

An output shaft 13 of the engine 3 is connected to an input shaft 14 of the power split mechanism 6 connected to the carrier 12 so that output power of the engine 3 is applied to the carrier 12. Optionally, an additional gear unit (not shown) may be interposed between the input shaft 14 and the carrier 12, and a damper device and a torque converter (neither of which are shown) may be interposed between the output shaft 13 and the input shaft 14.

The sun gear 9 is connected to the first motor 4. In the vehicle Ve shown in FIG. 1, the power split section 7 and the first motor 4 are arranged concentrically with a rotational center axis of the engine 3, and the first motor 4 is situated on an opposite side of the engine 3 across the power split section 7. The transmission section 8 is interposed coaxially between the power split section 7 and the engine 3.

The transmission section 8 is also a single-pinion planetary gear unit comprising: a sun gear 15; a ring gear 16 as an internal gear arranged concentrically around the sun gear 15; a plurality of pinion gears 17 interposed between the sun gear 15 and the ring gear 16 while being meshed with the both gears 15 and 16; and a carrier 18 supporting the pinion gears 17 in a rotatable manner. Thus, the transmission section 8 is also adapted to perform a differential action among the sun gear 15, the ring gear 16, and the carrier 18. Accordingly, the transmission section 8 serves as a second differential mechanism of the embodiment. In the transmission section 8, the sun gear 15 is connected to the ring gear 10 of the power split section 7, and the ring gear 16 is connected to an output gear 19. In the power split mechanism 6, accordingly, the ring gear 16 serves as a fourth rotary element, the sun gear 15 serves as a fifth rotary element, and the carrier 18 serves as a sixth rotary element.

In order to operate the power split section 7 and the transmission section 8 as a complex planetary gear unit, a first clutch CL1 as a first engagement device is disposed to selectively connect the carrier 18 of the transmission section 8 to the carrier 12 of the power split section 7 connected to the input shaft 14. The first clutch CL1 includes a pair of rotary members 12a and 12b selectively engaged to each other to transmit the torque. Specifically, the rotary member 12a is fitted onto the input shaft 14, and the rotary member 12b is connected to the carrier 18 of the transmission section 8. For example, a wet-type multiple plate clutch or a dog clutch may be adopted as the first clutch CL1. Otherwise, a normally stay clutch may also be adopted as the first clutch CL1. An engagement state of the normally stay clutch is switched upon reception of the command signal, and the normally stay clutch stays in the current engagement state even if the signal transmission thereto is interrupted. Thus, in the drive unit 2 shown in FIG. 1, the power split section 7 is connected to the transmission section 8 to serve as a complex planetary gear unit by engaging the first clutch CL1. In the complex planetary gear unit thus formed, the carrier 12 of the power split section 7 is connected to the carrier 18 of the transmission section 8 to serve as an input element, the sun gear 9 of the power split section 7 serves as a reaction element, and the ring gear 16 of the transmission section 8 serves as an output element. That is, the complex planetary gear unit is configured such that the input shaft 14, an output shaft 4a of the first motor 4, and an after-mentioned driven gear 21 are allowed to rotate in a differential manner.

A second clutch CL2 as a second engagement device is disposed to rotate the rotary elements of the transmission section 8 integrally. For example, a friction clutch, a dog clutch, and a normally stay clutch may also be adopted as the second clutch CL2 to selectively connect the carrier 18 to the ring gear 16 or the sun gear 15, or to connect the sun gear 15 to the ring gear 16. In the drive unit 2 shown in FIG. 1, specifically, the second clutch CL2 is engaged to connect the carrier 18 to the ring gear 16 to rotate the rotary elements of the transmission section 8 integrally. The second clutch CL2 includes a pair of rotary members 18a and 18b selectively engaged to each other to transmit the torque. Specifically, the rotary member 18a is connected to the carrier 18 of the transmission section 8, and the rotary member 18b is connected to the ring gear 16 of the transmission section 8.

A counter shaft 20 extends parallel to a common rotational axis of the engine 3, the power split section 7, and the transmission section 8. A driven gear 21 is fitted onto one end of the counter shaft 20 to be meshed with the output gear 19, and a drive gear 22 is fitted onto the other end of the counter shaft 20 to be meshed with a ring gear 24 of a differential gear unit 23 as a final reduction unit. The driven gear 21 is also meshed with a drive gear 26 fitted onto a rotor shaft 25 of the second motor 5 so that power or torque of the second motor 5 is synthesized with power or torque of the output gear 19 at the driven gear 21 to be distributed from the differential gear unit 23 to the front wheels 1R and 1L via each driveshaft 27.

In order to selectively stop a rotation of the engine 3 when operating the first motor 4 to propel the vehicle Ve, a brake B1 as a third engagement device is arranged in the drive unit 2. For example, a frictional engagement device or a dog brake may be adopted as the brake B1, and the brake B1 is fixed to a predetermined stationary member in radially outer side of the output shaft 13 or the input shaft 14. The carrier 12 of the power split section 7 and the carrier 18 of the transmission section 8 are allowed to serve as reaction elements, and the sun gear 9 of the power split section 7 is allowed to serve as an input element by applying the brake B1 to halt the output shaft 13 or the input shaft 14. To this end, the brake B1 may be adapted to stop the rotation of the output shaft 13 or the input shaft 14 not only completely but also incompletely to apply a reaction torque to those shafts. Alternatively, a one-way clutch may be used instead of the brake B1 to restrict a reverse rotation of the output shaft 13 or the input shaft 14.

A first power control system 28 is connected to the first motor 4, and a second power control system 29 is connected to the second motor 5. Each of the first power control system 28 and the second power control system 29 includes an inverter and a converter. The first power control system 28 and the second power control system 29 are connected to each other, and also connected individually to an electric storage device 30 including a lithium ion battery, a capacitor, and a solid-state battery. For example, when the first motor 4 is operated as a generator while establishing a reaction torque, an electric power generated by the first motor 4 may be supplied directly to the second motor 5 without passing through the electric storage device 30.

Characteristics of the lithium ion battery, the capacitor, and the solid-state battery adopted as the electric storage device 30 are different from one another. The electric storage device 30 may also be formed by combining those storage devices arbitrarily according to need.

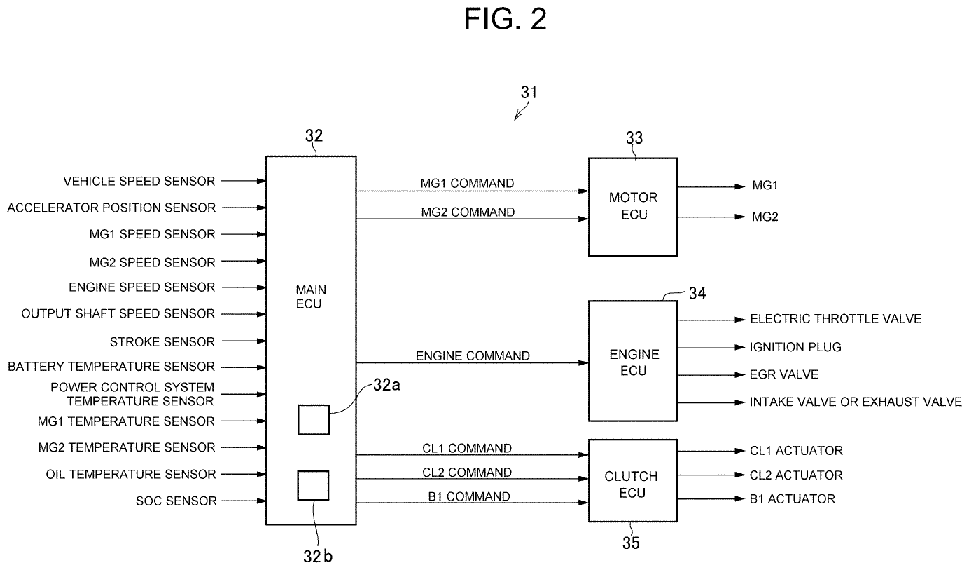

In order to control the first power control system 28, the second power control system 29, the engine 3, the first clutch CL1, the second clutch CL2, the brake B1 and so on, the vehicle Ve is provided with an electronic control unit (to be abbreviated as the “ECU” hereinafter) 31 as a controller. The ECU 31 comprises a microcomputer as its main constituent, and as shown in FIG. 2, the ECU 31 includes a main ECU 32, a motor ECU 33, an engine ECU 34 and a clutch ECU 35.

The main ECU 32 is configured to execute a calculation based on incident data transmitted from sensors as well as maps and formulas installed in advance, and transmits a calculation result to the motor ECU 33, the engine ECU 34 and the clutch ECU 35 in the form of command signal. For example, the main ECU 32 receives data about: a vehicle speed; an accelerator position; a speed of the first motor 4; a speed of the second motor 5; a speed of the output shaft 13 of the engine 3; an output speed such as a rotational speed of the counter shaft 20 of the transmission section 8; strokes of pistons (or actuators) of the clutches CL1, CL2, and the brake B1; a temperature of the electric storage device 30; temperatures of the power control systems 28 and 29; a temperature of the first motor 4; a temperature of the second motor 5; a temperature of oil (i.e., ATF) lubricating the power split section 7 and the transmission section 8; a state of charge (to be abbreviated as the “SOC” hereinafter) level of the electric storage device 30 and so on. The main ECU 32 is provided with a mode determiner 32a that determines an operating mode on a map, and a mode changer 32b that determines to shift the operating mode. The map includes a map for shifting the operating mode between an after-mentioned electric vehicle mode and a hybrid mode, and a map for shifting the operating mode between a Low mode and a High mode.

Specifically, command signals of output torques and speeds of the first motor 4 and the second motor 5 are transmitted from the main ECU 32 to the motor ECU 33. Likewise, command signals of an output torque and a speed of the engine 3 are transmitted from the main ECU 32 to the engine ECU 34, and command signals of torque transmitting capacities (including “0”) of the clutches CL1, CL2, and the brake B1 are transmitted from the main ECU 32 to the clutch ECU 35.

The motor ECU 33 calculates current values applied to the first motor 4 and the second motor 5 based on the data transmitted from the main ECU 32, and transmits calculation results to the motors 4 and 5 in the form of command signals. In the vehicle Ve, an AC motor is adopted as the first motor 4 and the second motor 5. In order to control the AC motor, the command signals transmitted from the motor ECU 33 include command signals for controlling a frequency of a current generated by the inverter and a voltage value boosted by the converter.

The engine ECU 34 calculates current values and pulse numbers to control opening degrees of an electronic throttle valve, an EGR (Exhaust Gas Restriction) valve, an intake valve, and an exhaust valve, and to activate an ignition plug, based on the data transmitted from the main ECU 32. Calculation results are transmitted from the engine ECU 34 to the valves and the plug in the form of command signals. Thus, the engine ECU 34 transmits command signals for controlling a power, an output torque and a speed of the engine 3.

The clutch ECU 35 calculates current values supplied to actuators controlling engagement pressures of the clutches CL1, CL2, and the brake B1 based on the data transmitted from the main ECU 32, and transmits calculation results to the actuators of those engagement devices in the form of command signals.

In the vehicle Ve, an operating mode may be selected from a hybrid mode (to be abbreviated as the “HV mode” hereinafter) in which the vehicle Ve is propelled by a drive torque generated by the engine 3, and an electric vehicle mode (to be abbreviated as the “EV mode” hereinafter) in which the vehicle Ve is propelled by drive torques generated by the first motor 4 and the second motor 5 without operating the engine 3. The HV mode may be selected from a Hybrid-Low mode (to be abbreviated as the “HV-Low mode” hereinafter), a Hybrid-High mode (to be abbreviated as the “HV-High mode” hereinafter), and a fixed mode. Specifically, in the HV-Low mode, a rotational speed of the engine 3 (i.e., a rotational speed of the input shaft 14) is increased higher than a rotational speed of the ring gear 16 of the transmission section 8 when a rotational speed of the first motor 4 is reduced to substantially zero. In turn, in the HV-High mode, a rotational speed of the engine 3 is reduced lower than a rotational speed of the ring gear 16 of the transmission section 8 when a rotational speed of the first motor 4 is reduced to substantially zero. Further, in the fixed mode, the engine 3 and the ring gear 16 of the transmission section 8 are always rotated at substantially same speeds. Here, it is to be noted that a toque amplification factor in the HV-Low mode is greater than that in the HV-High mode.

The EV mode may be selected from a dual-motor mode in which both of the first motor 4 and the second motor 5 generate drive torques to propel the vehicle Ve, and a single-motor mode (or a disconnecting mode) in which only the second motor 5 generates a drive torque to propel the vehicle Ve. Further, the dual-motor mode may be selected from an Electric Vehicle-Low mode (to be abbreviated as the “EV-Low mode” hereinafter) in which a torque of the first motor 4 is multiplied by a relatively larger factor, and an Electric Vehicle-High mode (to be abbreviated as the “EV-High mode” hereinafter) in which a torque of the first motor 4 is multiplied by a factor smaller than that in the EV-Low mode. In the single-motor mode, the vehicle Ve is powered only by the second motor 5 while disengaging both of the first clutch CL1 and the second clutch CL2 or engaging any one of the first clutch CL1 and the second clutch CL2.

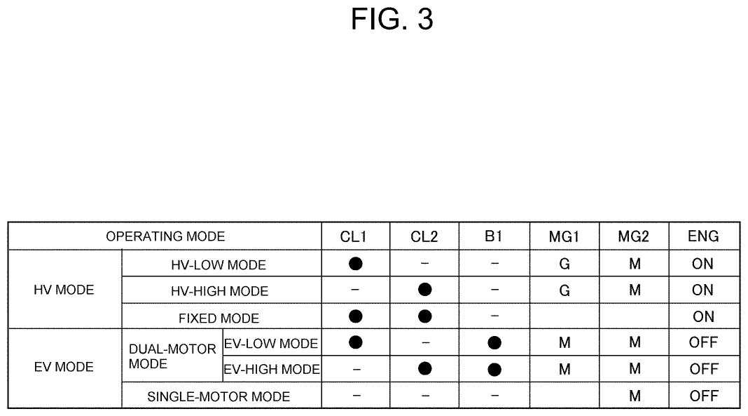

FIG. 3 shows engagement states of the first clutch CL1, the second clutch CL2, and the brake B1, and operating conditions of the first motor 4, the second motor 5, and the engine 3 in each operating mode. In FIG. 3, “•” represents that the engagement device is in engagement, “−” represents that the engagement device is in disengagement, “G” represents that the motor serves mainly as a generator, “M” represents that the motor serves mainly as a motor, blank represents that the motor serves as neither a motor nor a generator or that the motor is not involved in propulsion of the vehicle Ve, “ON” represents that the engine 3 generates a drive torque, and “OFF” represents that the engine 3 does not generate a drive torque.

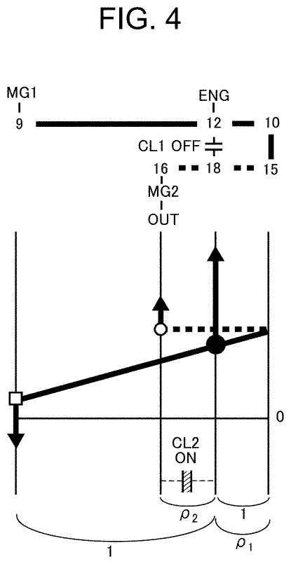

Rotational speeds of the rotary elements of the power split mechanism 6, and directions of torques of the engine 3, the first motor 4, and the second motor 5 in each operating mode are indicated in FIGS. 4 to 9. In the nomographic diagrams shown in FIGS. 4 to 9, a distance between the vertical lines represents a gear ratio of the power split mechanism 6, a vertical distance on the vertical line from the horizontal base line represents a rotational speed of the rotary member, an orientation of the arrow represents a direction of the torque, and a length of the arrow represents a magnitude of the torque.

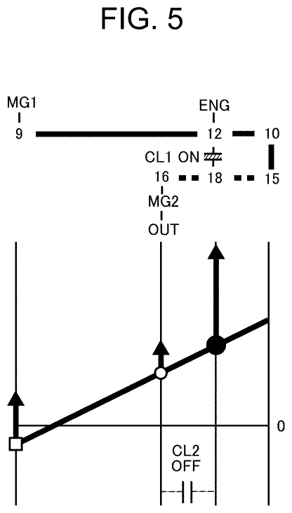

As indicated in FIG. 4, in the HV-High mode, the second clutch CL2 is engaged, and the engine 3 generates a drive torque while establishing a reaction torque by the first motor 4. As indicated in FIG. 5, in the HV-Low mode, the first clutch CL1 is engaged, and the engine 3 generates a drive torque while establishing a reaction torque by the first motor 4. In the HV-High mode and the HV-Low mode, a rotational speed of the first motor 4 is controlled in such a manner as to optimize a total energy efficiency in the drive unit 2 including a fuel efficiency of the engine 3 and a driving efficiency of the first motor 4. Specifically, the total energy efficiency in the drive unit 2 may be calculated by dividing a total energy consumption by a power to rotate the front wheels 1R and 1L. A rotational speed of the first motor 4 may be varied continuously, and the rotational speed of the engine 3 is governed by the rotational speed of the first motor 4 and a speed of the vehicle Ve. That is, the power split mechanism 6 may serve as a continuously variable transmission.

As a result of establishing a reaction torque by the first motor 4, the first motor 4 serves as a generator. In this situation, therefore, a power of the engine 3 is partially translated into an electric energy, and the remaining power of the engine 3 is delivered to the ring gear 16 of the transmission section 8. Specifically, the reaction torque established by the first motor 4 is governed by a split ratio of the torque delivered from the engine 3 to the first motor 4 side through the power split mechanism 6. Such split ratio between the torque delivered from the engine 3 to the first motor 4 side through the power split mechanism 6 and the torque delivered from the engine 3 to the ring gear 16 differs between the HV-Low mode and the HV-High mode.

Given that the torque delivered to the first motor 4 side is “1”, a ratio of the torque applied to the ring gear 16 in the HV-Low mode may be expressed as “1/(ρ1·ρ2)”, and a ratio of the torque applied to the ring gear 16 in the HV-High mode may be expressed as “1/(ρ1)”. In other words, given that the torque of the engine 3 is “1”, a ratio of the torque of the engine 3 delivered to the ring gear 16 in the HV-Low mode may be expressed as “1/(1−(ρ1·ρ2))”, and a ratio of the torque of the engine 3 delivered to the ring gear 16 in the HV-High mode may be expressed as “1/(ρ1+1)”. In the above expressions, “ρ1” is a gear ratio of the power split section 7 (i.e., a ratio between the number of teeth of the ring gear 10 and the number of teeth of the sun gear 9), and “ρ2” is a gear ratio of the transmission section 8 (i.e., a ratio between the number of teeth of the ring gear 16 and the number of teeth of the sun gear 15). Specifically, “ρ1” and “ρ2” are smaller than “1” each. That is, in the HV-Low mode, a ratio of the torque delivered to the ring gear 16 is increased in comparison with that in the HV-High mode.

Here, when the speed of the engine 3 is increased by the torque generated by the engine 3, the output torque of the engine 3 is reduced by a torque required to increase the speed of the engine 3. In the HV mode, the electric power generated by the first motor 4 may be supplied to the second motor 5, and in addition, the electric power accumulated in the electric storage device 30 may also be supplied to the second motor 5 as necessary.

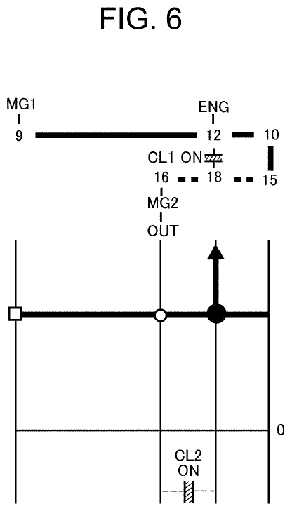

In the fixed mode, as indicated in FIG. 6, both of the first clutch CL1 and the second clutch CL2 are engaged so that all of the rotary elements in the power split mechanism 6 are rotated at same speeds. In other words, the output power of the engine 3 will not be translated into an electric energy by the first motor 4 and the second motor 5. For this reason, a power loss associated with such energy conversion will not be caused in the fixed mode and hence power transmission efficiency can be improved.

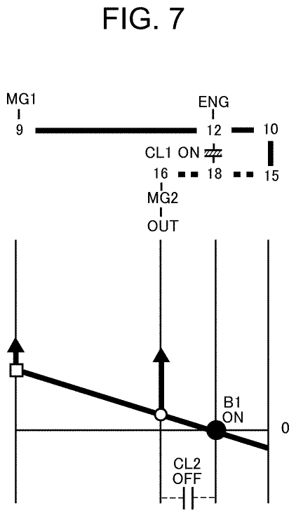

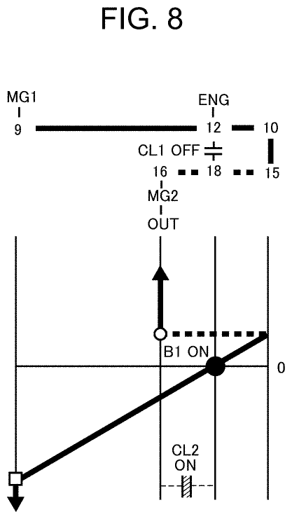

As indicated in FIGS. 7 and 8, in the EV-Low mode and the EV-High mode, the brake B1 is engaged, and the first motor 4 and the second motor 5 generates the drive torques to propel the vehicle Ve. As indicated in FIG. 7, in the EV-Low mode, the vehicle Ve is propelled by the drive torques generated by the first motor 4 and the second motor 5 while engaging the brake B1 and the first clutch CL1. In this case, the brake B1 establishes a reaction torque to restrict a rotation of the output shaft 13 or the carrier 12. In the EV-Low mode, the first motor 4 is rotated in the forward direction while generating the torque in a direction to increase a rotational speed. As indicated in FIG. 8, in the EV-High mode, the vehicle Ve is propelled by the drive torques generated by the first motor 4 and the second motor 5 while engaging the brake B1 and the second clutch CL2. In this case, the brake B1 also establishes a reaction torque to restrict a rotation of the output shaft 13 or the carrier 12. In the EV-High mode, the first motor 4 is rotated in the opposite direction (i.e., in a reverse direction) to the rotational direction of the engine 3 in the HV mode, while generating torque in a direction to increase a rotational speed.

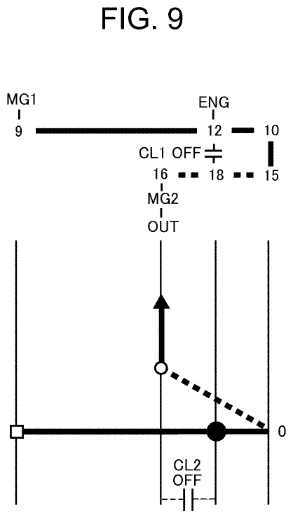

In the EV-Low mode, a ratio of a rotational speed of the ring gear 16 of the transmission section 8 to a rotational speed of the first motor 4 is reduced smaller than that in the EV-High mode. That is, in the EV-Low mode, the rotational speed of the first motor 4 at a predetermined speed is increased higher than that in the EV-High mode. In other words, a speed reducing ratio in the EV-Low mode is greater than that in the EV-High mode. In the EV-Low mode, therefore, a larger drive force may be generated. Here, in the drive unit 2 shown in FIG. 1, the rotational speed of the ring gear 16 corresponds to a rotational speed of an output member, and the following explanation will be made on the assumption that a gear ratio among each member from the ring gear 16 to the front wheels 1R and 1L is “1” for the sake of convenience. As indicated in FIG. 9, in the single-motor mode, only the second motor 5 generates the drive torque, and both of the first clutch CL1 and the second clutch CL2 are disengaged. In the single-motor mode, therefore, all of the rotary elements of the power split mechanism 6 are stopped. For this reason, the engine 3 and the first motor 4 will not be rotated passively, and hence a power loss can be reduced.

In the vehicle Ve, the operating mode is selected on the basis of an SOC level of the electric storage device 30, a vehicle speed, a required drive force and so on. According to the embodiment, a selection pattern of the operating mode may be selected from a Charge Sustaining mode (to be abbreviated as the “CS mode” hereinafter) in which the operating mode is selected in such a manner as to maintain the SOC level of the electric storage device 30 as far as possible, and a Charge Depleting mode (to be abbreviated as the “CD mode” hereinafter) in which the operating mode is selected in such a manner as to propel the vehicle Ve while consuming the electric power accumulated in the electric storage device 30. Specifically, the CS mode is selected when the SOC level of the electric storage device 30 is relatively low, and the CD mode is selected when the SOC level of the electric storage device 30 is relatively high.

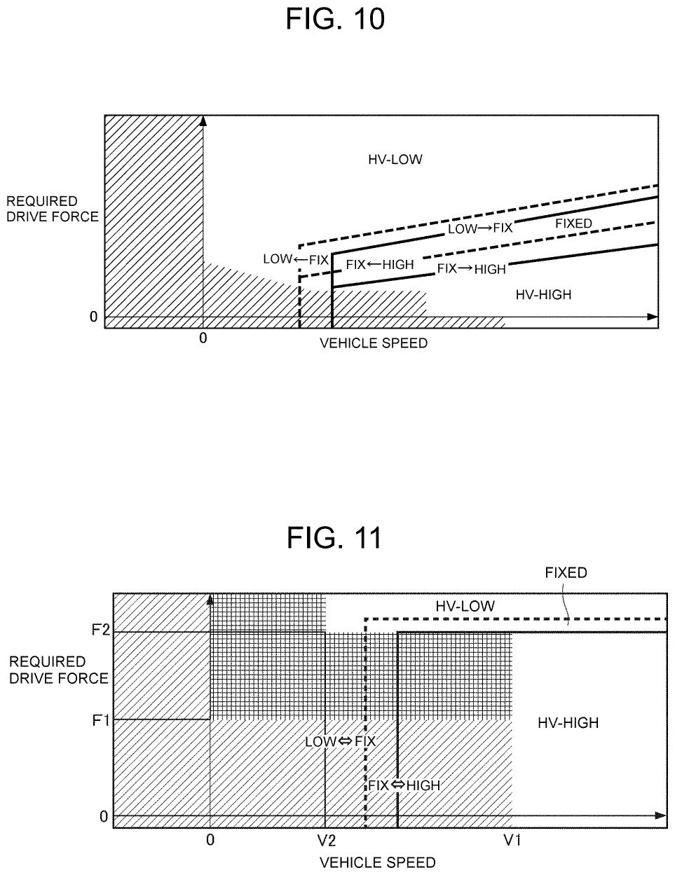

FIG. 10 shows an example of a map used to select the operating mode during propulsion in the CS mode. In FIG. 10, the vertical axis represents a required drive force, and the horizontal axis represents a vehicle speed. In order to select the operating mode of the vehicle Ve, the vehicle speed may be detected by a vehicle speed sensor, and the required drive force may be estimated based on an accelerator position detected by an accelerator sensor.

In FIG. 10, the hatched region is an area where the single-motor mode is selected, and the hatched region is determined based on specifications of the second motor 5. In the CS mode, the single-motor mode is selected when the vehicle Ve is propelled in a reverse direction irrespective of the required drive force, and when the vehicle Ve is propelled in a forward direction and the required drive force is small (or when decelerating).

During forward propulsion in the CS mode, the HV mode is selected when a large drive force is required. In the HV mode, the drive force may be generated from a low speed range to a high speed range. When the SOC level of the electric storage device 30 falls close to a lower limit level, therefore, the HV mode may be selected even if an operating point governed by the required drive force and the vehicle speed falls within the hatched region.

As described, the HV mode may be selected from the HV-Low mode, the HV-High mode, and the fixed mode. In the CS mode, specifically, the HV-Low mode is selected when the vehicle speed is relatively low or the required drive force is relatively large, the HV-High mode is selected when the vehicle speed is relatively high and the required drive force is relatively small, and the fixed mode is selected when the operating point falls between a region where the HV-Low mode is selected and a region where the HV-High mode is selected.

In the CS mode, the operating mode is shifted from the fixed mode to the HV-Low mode when the operating point is shifted across the “LOW-FIX” line from right to left, or when the operating point is shifted across the “LOW-FIX” line upwardly from the bottom. By contrast, the operating mode is shifted from the HV-Low mode to the fixed mode when the operating point is shifted across the “LOW-FIX” line from left to right, or when the operating point is shifted across the “LOW-FIX” line downwardly from the top. Likewise, the operating mode is shifted from the HV-High mode to the fixed mode when the operating point is shifted across the “FIX-HIGH” line from right to left, or when the operating point is shifted across the “FIX-HIGH” line upwardly from the bottom. By contrast, the operating mode is shifted from the fixed mode to the HV-High mode when the operating point is shifted across the “FIX-HIGH” line from left to right, or when the operating point is shifted across the “FIX-HIGH” line downwardly from the top.

FIG. 11 shows an example of a map used to select the operating mode during propulsion in the CD mode. In FIG. 11, the vertical axis also represents the required drive force, and the horizontal axis also represents the vehicle speed.

In FIG. 11, the hatched region is also an area where the single-motor mode is selected. In the CD mode, the single-motor mode is also selected when the vehicle Ve is propelled in the reverse direction irrespective of the required drive force, and when the vehicle Ve is propelled in the forward direction and the required drive force is smaller than a first threshold force value F1 (or when decelerating). Such region where the single-motor mode is selected is also determined based on specifications of the second motor 5 and so on.

During forward propulsion in the CD mode, the dual-motor mode is selected when the drive force larger than the first threshold force value F1 is required. In this case, the HV mode is selected when the vehicle speed is higher than a first threshold speed V1, or when the vehicle speed is higher than a second threshold speed V2 and the required drive force is greater than a second threshold force value F2. As described, in the HV mode, the drive force may be generated from the low speed range to the high speed range. When the SOC level of the electric storage device 30 falls close to the lower limit level, therefore, the HV mode may be selected even if the operating point falls within the regions where the single-motor mode and the dual-motor mode are selected.

In the CD mode, the HV-Low mode is also selected when the vehicle speed is relatively low and the required drive force is relatively large, the HV-High mode is also selected when the vehicle speed is relatively high and the required drive force is relatively small, and the fixed mode is also selected when the operating point falls between the region where the HV-Low mode is selected and the region where the HV-High mode is selected.

In the CD mode, specifically, the operating mode is shifted between the fixed mode and the HV-Low mode when the operating point is shifted across the “LOW↔FIX” line. Likewise, the operating mode is shifted between the HV-High mode and the fixed mode when the operating point is shifted across the “FIX↔HIGH”.

In the maps shown in FIGS. 10 and 11, the regions of each of the operating mode and the lines defining the regions may be altered depending on temperatures of the members of the drive unit 2, the electric storage device 30, the power control systems 28 and 29, and an SOC level of the electric storage device 30.

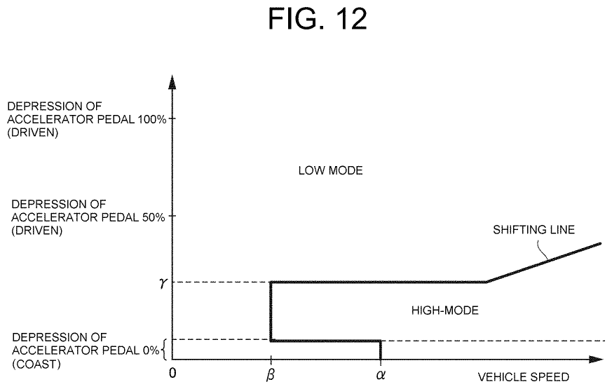

As described, the drive torque generated in the Low mode is larger than the drive torque generated in the High mode in both of the HV mode and the EV mode. For example, if the vehicle Ve coasting without depressing the accelerator pedal is accelerated by depressing the accelerator pedal, the operating mode of the power split mechanism 6 (i.e., the operating mode of the vehicle Ve) may be shifted from the Low-mode to the High mode, and then shifted to the Low mode again. One example of the shifting map of the operating mode of the power split mechanism 6 between the Low mode and the High mode is shown in FIG. 12. In FIG. 12, the vertical axis represents a depression of the accelerator pedal, and the horizontal axis represents a speed of the vehicle Ve. That is, in the map shown in FIG. 12, an operating point of the vehicle Ve is governed by a position of the accelerator pedal and a current speed of the vehicle Ve.

As can be seen from FIG. 12, when the vehicle Ve coasts without depressing the accelerator pedal, that is, if the depression of the accelerator pedal is 0%, the Low mode is maintained until the speed of the vehicle Ve reaches a first threshold speed α, and the operating mode is shifted to the High mode upon the reaching of the first threshold speed α. If the depression of the accelerator pedal is not so deep and falls within a range between 0% and a reference value γ %, the Low mode is maintained until the speed of the vehicle Ve reaches a second threshold speed β that is lower than the first threshold speed α, and the operating mode is shifted to the High mode upon the reaching of the second threshold speed β. If the depression of the accelerator pedal is equal to or deeper than the reference value γ %, the Low mode is maintained in most situations.

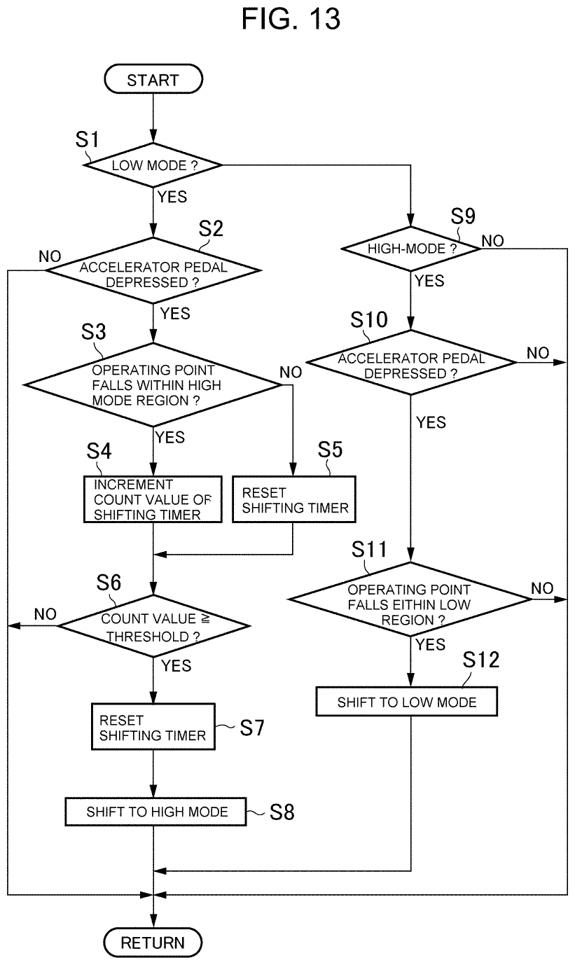

Specifically, given that the accelerator pedal is depressed to accelerate the vehicle Ve coasting at a speed between second threshold speed β and the first threshold speed α, the operating mode of the power split mechanism 6 is shifted from the Low mode to the High mode. In this case, if the accelerator pedal is depressed to the reference value γ % or deeper, the operating mode of the power split mechanism 6 will be shifted from the Low-mode to the High mode, and then shifted to the Low mode again. As a result of shifting the operating mode repeatedly, responses of drive force and acceleration may be reduced. In order to avoid such disadvantage, the control system according to the exemplary embodiment of the present disclosure is configured to execute a routine shown in FIG. 13 so as to maintain the Low mode as much as possible.

The routine shown in FIG. 13 is commenced when the driver attempts to accelerate the vehicle Ve coasting without depressing the accelerator pedal. For example, the routine shown in FIG. 13 is commenced when the driver executes a kickdown shifting, when the driver turns on a switch to select a sporty mode to accelerate the vehicle Ve sharply, or when the driver depresses the accelerator pedal at a rate faster than a threshold speed.

At step S1, it is determined whether the vehicle Ve is operated in the Low mode. In other words, it is determined at step S1 whether the first clutch CL1 is engaged and the second clutch CL2 is disengaged. Specifically, the answer of step S1 will be YES if the accelerator pedal is not depressed and a speed of the vehicle Ve is lower than the first threshold speed α shown in FIG. 12.

If the vehicle Ve is operated in the Low mode so that the answer of step S1 is YES, the routine progresses to step S2 to determine whether the accelerator pedal is depressed. In other words, it is determined at step S2 whether the driver intends to accelerate the vehicle Ve. If the accelerator pedal is not depressed so that the answer of step S2 is NO, the routine returns.

By contrast, if the accelerator pedal is depressed so that the answer of step S2 is YES, the routine progresses to step S3 to determine whether the operating point in the map shown in FIG. 12 is shifted from a region where the Low mode is selected (as will be simply called the “Low mode region” hereinafter) to a region where the High mode is selected (as will be simply called the “High mode region” hereinafter). If the operating point in the map shown in FIG. 12 falls within the High mode region so that the answer of step S3 is YES, the routine progresses to step S4 to start a time measurement from a point at which the operating point has been shifted to the High mode region. In other words, the routine progresses to step S4 to increment a count value of a shifting timer with an elapsed time from the point at which the operating point has been shifted to the High mode region.

According to the exemplary embodiment of the present disclosure, even if the operating point in the map shown in FIG. 12 is shifted to the High mode region, the operating mode will not be shifted immediately to the High mode until the count value of the shifting timer from the point at which the operating point has been shifted to the High mode region reaches a preset threshold time period. In other words, the control system according to the exemplary embodiment of the present disclosure is configured to delay a timing to determine whether to shift the operating mode from the Low mode to the High mode. By contrast, if the operating point in the map shown in FIG. 12 does not fall within the High mode region so that the answer of step S3 is NO, the routine progresses to step S5 to reset the count value of the shifting timer.

Then, it is determined at step S6 whether the count value of the shifting timer from the point at which the operating point has been shifted to the High mode region reaches the threshold time period. In other words, it is determined at step S6 whether the elapsed period of time from the point at which the operating point has been shifted to the High mode region reaches the threshold time period. For example, the threshold time period of the count value of the shifting timer may be set between 0.5 and 1.0 second(s). If the count value of the shifting timer is still shorter than the threshold time period so that the answer of step S6 is NO, the routine returns without shifting the operating mode to the High mode. In this situation, therefore, the operating mode is maintained to the Low mode.

By contrast, if the count value of the shifting timer reaches the threshold time period so that the answer of step S6 is YES, the routine progresses to step S7 to reset the count value of the shifting timer. Then, at step S8, the operating mode is shifted from the Low mode to the High mode by disengaging the first clutch CL1 while engaging the second clutch CL2. Here, it is to be noted that steps S7 and S8 may be executed simultaneously, and an order to execute steps S7 and S8 may be switched.

Whereas, if the vehicle Ve is not operated in the Low mode so that the answer of step S1 is NO, the routine progresses to step S9 to determine whether the vehicle Ve is operated in the High mode. In other words, it is determined at step S9 whether the first clutch CL1 is disengaged and the second clutch CL2 is engaged. Specifically, the answer of step S9 will be YES if the accelerator pedal is not depressed and a speed of the vehicle Ve is equal to or higher than the first threshold speed a shown in FIG. 12.

If the vehicle Ve is not operated in the High mode so that the answer of step S9 is NO, the routine returns. For example, the answer of step S9 will be NO during a transient state of a shifting operation to the Low mode or High Mode, or if the vehicle Ve is operated in the fixed mode while engaging both of the first clutch CL1 and the second clutch CL2.

By contrast, if the vehicle Ve is operated in the High mode so that the answer of step S9 is YES, the routine progresses to step S10 to determine whether the accelerator pedal is depressed. In other words, it is determined at step S10 whether the driver intends to accelerate the vehicle Ve. If the accelerator pedal is not depressed so that the answer of step S10 is NO, the routine returns.

By contrast, if the accelerator pedal is depressed so that the answer of step S10 is YES, the routine progresses to step S11 to determine whether the operating point in the map shown in FIG. 12 is shifted from the High mode region to the Low mode region. If the operating point in the map shown in FIG. 12 falls within the Low mode region so that the answer of step S11 is YES, the routine progresses to step S12 to shift the operating mode from the High mode to the Low mode. In this case, the operating mode is shifted from the High mode to the Low mode without delay in response to such displacement of the operating point in the map shown in FIG. 12, by engaging the first clutch CL1 while disengaging the second clutch CL2.

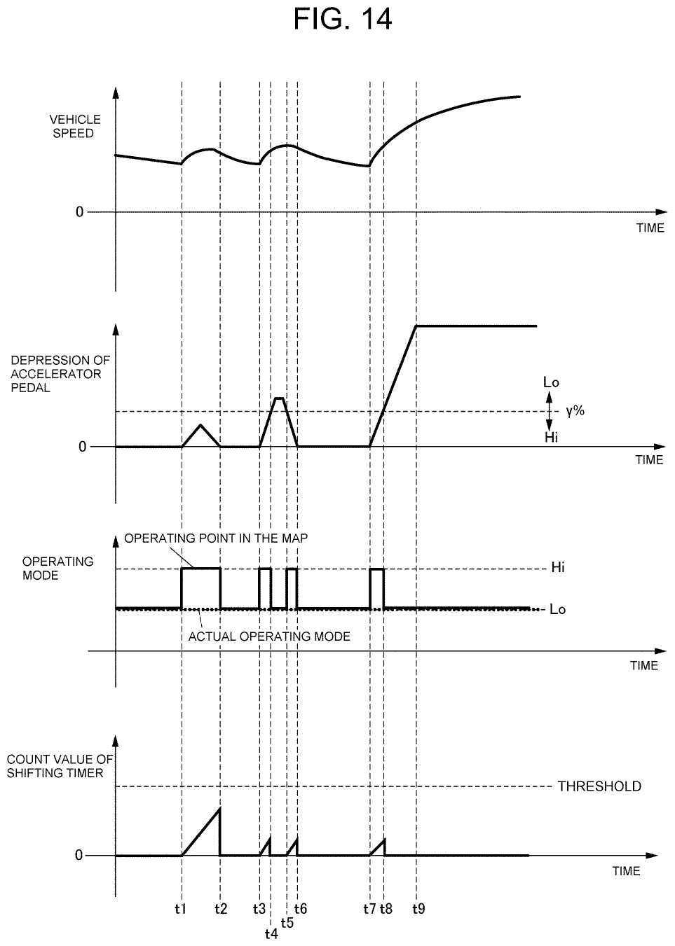

Turing to FIG. 14, there are shown temporal changes in the conditions of the vehicle Ve during execution of the routine shown in FIG. 13. Specifically, FIG. 14 shows a situation in which the operating point in the map shown in FIG. 12 is shifted from the Low mode region to the High mode region by depressing the accelerator pedal, but the count value of the shifting timer from the point at which the operating point has been shifted to the High mode region is shorter than the threshold time period and the Low mode is maintained.

The vehicle Ve coasts without depressing the accelerator pedal before point t1, and the accelerator pedal is depressed at point t1 so that the operating point in the map shown in FIG. 12 is shifted from the Low mode region to the High mode region. In this situation, a time measurement of the shifting timer is commenced, and the actual operating mode is maintained to the Low mode as indicated by the dashed line in FIG. 14 until the count value of the shifting timer from point t1 reaches the threshold time period.

The accelerator pedal is returned before point t2 so that a depression of the accelerator pedal is reduced to 0% at point t2, and the vehicle Ve starts coasting again from point t2. In this situation, therefore, the operating point in the map shown in FIG. 12 is shifted from the High mode region to the Low mode region again, and the count value of the shifting timer is reset. That is, the count value of the shifting timer does not reach the threshold time period during the period from point t1 to point t2. For this reason, the actual operating mode is not shifted to the high mode during the period from point t1 to point t2 in spite of the fact that the operating point has been shifted to the High mode region.

The accelerator pedal is depressed again at point t3 so that the operating point in the map shown in FIG. 12 is shifted again from the Low mode region to the High mode region. Consequently, the time measurement of the shifting timer is commenced again and the operating mode is maintained to the Low mode from point t3. In this situation, the accelerator pedal is still being depressed, and eventually the depression of the accelerator pedal reaches the reference value γ % shown in FIG. 12 at point t4. Therefore, the operating point in the map shown in FIG. 12 is shifted from the High mode region to the Low mode region again at point t4, and the count value of the shifting timer is reset. In this situation, the count value of the shifting timer also does not reach the threshold time period during the period from point t3 to point t4. For this reason, the actual operating mode is also not shifted to the High mode during the period from point t3 to point t4 in spite of the fact that the operating point has been temporarily shifted to the High mode region.

The position of the accelerator pedal is maintained from point t4 so that the operating point in the map shown in FIG. 12 is maintained within the Low mode region and the actual operating mode is maintained to the Low mode from point t4. The accelerator pedal is returned before point t5 so that the depression of the accelerator pedal is reduced smaller than the reference value γ % at point t5, and that the operating point in the map shown in FIG. 12 is shifted from the Low mode region to the High mode region again at point t5. Consequently, the time measurement of the shifting timer is commenced again and the operating mode is maintained to the Low mode from point t5. In this situation, the accelerator pedal is still being returned, and eventually the depression of the accelerator pedal is reduced to 0% at point t6. Therefore, the operating point in the map shown in FIG. 12 is shifted from the High mode region to the Low mode region again at point t6, and the count value of the shifting timer is reset. In this situation, the count value of the shifting timer also does not reach the threshold time period during the period from point t5 to point t6. For this reason, the actual operating mode is also not shifted to the High mode during the period from point t5 to point t6 in spite of the fact that the operating point has been temporarily shifted to the High mode region.

The vehicle Ve starts coasting from point t6, and the accelerator pedal is depressed deeply at point t7. Consequently, the depression of the accelerator pedal is increased significantly from point t7, and the operating point in the map shown in FIG. 12 is shifted from the Low mode region to the High mode region at point t7. Therefore, the time measurement of the shifting timer is commenced again and the operating mode is maintained to the Low mode from point t7. In this situation, the accelerator pedal is still being depressed, and eventually the depression of the accelerator pedal reaches the reference value γ % at point t8. Consequently, the operating point in the map shown in FIG. 12 is shifted from the High mode region to the Low mode region again at point t8, and the count value of the shifting timer is reset. In this situation, the count value of the shifting timer also does not reach the threshold time period during the period from point t7 to point t8. For this reason, the actual operating mode is also not shifted to the High mode during the period from point t7 to point t8 in spite of the fact that the operating point has been temporarily shifted to the High mode region. Here, in the situation shown in FIG. 14, a speed of the vehicle Ve is changed in response to a position of the accelerator pedal.

Thus, according to the exemplary embodiment of the present disclosure, the operating mode is maintained to the Low mode for a certain period of time when the driver depresses the accelerator pedal to accelerate the coasting vehicle Ve. In other words, the timing to shift the operating mode from the Low mode to the High mode is delayed until the count value of the shifting timer from the point at which the operating point has been shifted to the High mode region reaches the preset threshold time period. According to the exemplary embodiment of the present disclosure, therefore, the actual operating mode will not be shifted from the Low mode to the High mode and returned to the Low mode again, even if the operating point in the map shown in FIG. 12 is shifted from the Low mode region to the Low mode region via the High mode region with an increase in the depression of the accelerator pedal. Since the operating mode is not shifted unnecessarily repeatedly, the drive force may be increased smoothly to accelerate the coasting vehicle Ve sharply in the Low mode when the accelerator pedal is depressed deeply.

In addition, since the operating mode is not shifted unnecessarily repeatedly, frequency to engage and disengage the engagement devices may be reduced so that engagement shocks of the engagement devices may be reduced.

In addition, according to the exemplary embodiment of the present disclosure, the operating mode of the vehicle Ve may be shifted between the HV mode and the EV mode without shifting from the Low mode to the High mode. According to the exemplary embodiment of the present disclosure, therefore, the operating mode of the vehicle Ve may be shifted smoothly between the HV mode and the EV mode.

Further, according to the exemplary embodiment of the present disclosure, the operating mode of the vehicle Ve is shifted from the High mode to the Low mode without delay in response to an actual displacement of the operating point in the map shown in FIG. 12. In this case, therefore, the operating mode of the vehicle Ve may be shifted from the High mode to the Low mode promptly without reducing responses of acceleration and drive force.

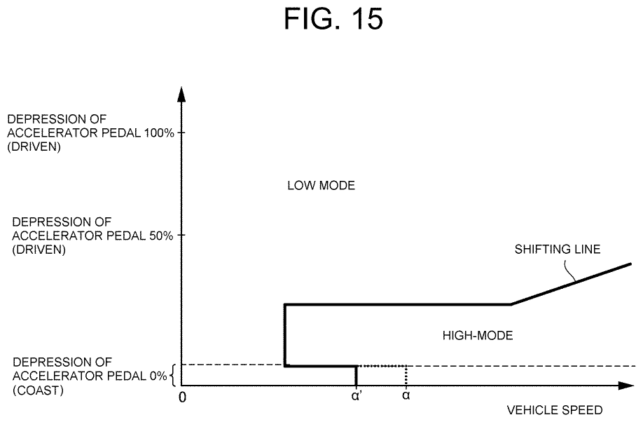

Although the above exemplary embodiments of the present disclosure have been described, it will be understood by those skilled in the art that the present disclosure should not be limited to the described exemplary embodiments, and various changes and modifications can be made within the scope of the present disclosure. For example, in a case that an economy mode is selected to reduce a fuel consumption of the engine 3 and electric consumptions of the motors 4 and 5, a shifting map of the operating mode shown in FIG. 15 may be employed instead of the shifting map shown in FIG. 12.

In the map shown in FIG. 15, a first threshold speed α′ to shift the operating mode from the Low mode to the High mode during coasting is shifted to a lower speed side so that the High mode region is expanded toward the lower speed side, compared to the High mode region in the shifting map shown in FIG. 12. Here, it is to be noted that a power loss may be caused by an energy circulation as a result of operating the first motor 4 by the electric power generated by the second motor 5, and that the power loss caused by such energy circulation is smaller in the High mode.

In the map shown in FIG. 15, the first threshold speed α′ may be altered within a speed range lower than the first threshold speed α shown in FIG. 12. In the case of employing the shifting map shown in FIG. 15, the routine shown in FIG. 13 is also commenced when the driver attempts to accelerate the vehicle Ve coasting in the economy mode to improve energy efficiency without depressing the accelerator pedal, or when the accelerator pedal is depressed at a rate slower than the threshold speed. In this case, the foregoing advantages of the present disclosure may also be achieved.

Lastly, in the exemplary embodiment of the present disclosure, the shifting map shown in FIG. 12 serves as a first map, and the map shown in FIG. 15 serves as a second map. As mentioned in the foregoing examples, the Low mode includes the HV-Low mode and the EV Low mode, and the High mode includes the HV-High mode and the EV-High mode.

What is claimed is:

1. A control system for a hybrid vehicle, comprising:
a prime mover including an engine and a motor;
a first differential mechanism that performs a differential action among a first rotary element that is connected to the engine, a second rotary element that is connected to the motor, and a third rotary element;
a second differential mechanism that performs a differential action among a fourth rotary element that is connected to a pair of drive wheels, a fifth rotary element that is connected to the third rotary element, and a sixth rotary element;
a first engagement device that selectively connects the first rotary element to the sixth rotary element; and
a second engagement device that selectively connects any two of the fourth rotary element, the fifth rotary element, and the sixth rotary element,
wherein an operating mode is selected from a plurality of modes including a low mode established by engaging the first engagement device, and a high mode established by engaging the second engagement device in which a torque delivered to the drive wheels is smaller compared to the low mode, and
the control system comprises a controller that shifts the operating mode,
the controller is configured to
shift the operating mode from the low mode to the high mode at a higher speed in a case that the hybrid vehicle coasts without depressing an accelerator pedal, compared to a case that the hybrid vehicle is propelled by depressing the accelerator pedal, and
delay a timing to shift the operating mode from the low mode to the high mode for a predetermined period of time when accelerating the coasting hybrid vehicle by depressing the accelerator pedal.

2. The control system for the hybrid vehicle as claimed in claim 1, the controller is further configured to
shift the operating mode between the low mode and the high mode with reference to a shifting map,
determine whether an operating point in the shifting map is shifted from a low mode region where the low mode is selected to a high mode region where the high mode is selected, and
delay the timing to shift the operating mode from the low mode to the high mode for the predetermined period of time, if the operating point in the shifting map is shifted from the low mode region to the high mode region by depressing the accelerator pedal to accelerate the coasting hybrid vehicle.

3. The control system for the hybrid vehicle as claimed in claim 2,
wherein the operating point is governed by a speed of the hybrid vehicle and a position of the accelerator pedal, and
the controller is further configured to determine a satisfaction of a condition to shift the operating mode from the low mode to the high mode based on the position of the accelerator pedal.

4. The control system for the hybrid vehicle as claimed in claim 2, wherein the controller is further configured to
determine whether the predetermined period of time has elapsed from a point at which the operating point in the map is shifted from the low mode region to the high mode region by depressing the accelerator pedal to accelerate the coasting hybrid vehicle, and
maintain the operating mode to the low mode if the predetermined period of time has not yet elapsed from the point at which the operating point in the map is shifted from the low mode region to the high mode region.

5. The control system for the hybrid vehicle as claimed in claim 4, wherein the controller is further configured to shift the operating mode from the low mode to the high mode if the predetermined period of time has elapsed from the point at which the operating point in the map is shifted from the low mode region to the high mode region.

6. The control system for the hybrid vehicle as claimed in claim 1,
wherein the operating mode further includes a hybrid vehicle mode in which the hybrid vehicle is powered at least by the engine, and an electric vehicle mode in which the hybrid vehicle is powered by the motor, and
the controller is further configured to delay the timing to shift the operating mode from the low mode to the high mode for the predetermined period of time if the operating point in the shifting map is shifted from the low mode region to the high mode region by depressing the accelerator pedal to accelerate the hybrid vehicle coasting in either the hybrid mode or the electric vehicle mode.

7. The control system for the hybrid vehicle as claimed in claim 2, wherein the controller is further configured to shift the operating mode from the high mode to the low mode without delay when accelerating the coasting hybrid vehicle by depressing the accelerator pedal.

8. The control system for the hybrid vehicle as claimed in claim 7, wherein the controller is further configured to shift the operating mode from the high mode to the low mode without delay if the operating point in the shifting map is shifted from the high mode region to the low mode region by depressing the accelerator pedal to accelerate the coasting hybrid vehicle.

9. The control system for the hybrid vehicle as claimed in claim 2,
wherein the shifting map includes
a first shifting map in which the operating mode is shifted from the low mode to the high mode at the higher speed in a case that the hybrid vehicle coasts without depressing an accelerator pedal, compared to a case that the hybrid vehicle is propelled by depressing the accelerator pedal, and
a second shifting map in which the operating mode is shifted from the low mode to the high mode at a lower speed compared to the first shifting map, in a case that the hybrid vehicle coasts without depressing an accelerator pedal, and
the controller is further configured to
delay the timing to shift the operating mode from the low mode to the high mode for the predetermined period of time with reference to the first shifting map in a case that the accelerator pedal is depressed at a rate equal to or faster than a threshold speed, or that a sporty mode is selected to accelerate the hybrid vehicle sharply, and
delay the timing to shift the operating mode from the low mode to the high mode for the predetermined period of time with reference to the second shifting map in a case that that the accelerator pedal is depressed at a rate slower than the threshold speed, or that an economy mode is selected to improve energy efficiency.
